(19) United States
(12) Patent Application Publication
(10) Pub. No.: US 2018/0279561 A1
(43) Pub. Date: Oct. 4, 2018

(54) GARDENING SYSTEM AND CONTAINER FOR SUPPORTING PLANT GROWTH AND RELATED METHODS

(71) Applicant: Syngenta Participations AG, Basel (CH)

(72) Inventors: Daniel Warden Kidder, Greensboro, NC (US); Gerardo Suazo, Greensboro, NC (US)

(73) Assignee: Syngenta Participations AG, Basel (CH)

(21) Appl. No.: 15/531,601

(22) PCT Filed: Nov. 30, 2015
(86) PCT No.: PCT/US2015/062935

§ 371 Date: May 30, 2017

Related U.S. Application Data
(60) Provisional application No. 62/085,676, filed on Dec. 1, 2014.

(51) Int. Cl. A01G 9/02; A01G 27/02

(52) U.S. Cl. CPC A01G 9/028; A01G 27/02

(57) ABSTRACT

Containerized plant growing solution systems are disclosed. Methods of making and using containerized plant growing solution systems are also disclosed.

### TECHNICAL FIELD

The present invention relates to containerized plant growing solution systems, and methods of making and using the same.

### BACKGROUND

As with many other industries throughout the world, increased demand is a major catalyst for evolution. The agriculture industry provides a clear example of one such industry wherein advancements in science and technology are among the key contributors to the dramatic transformation of plant production. Within this area of plant production, for example, the production of food crops has evolved from the simple domestication of plants into a highly sophisticated enterprise tasked with the tremendous goal of feeding the world's burgeoning population. Advances in fertilizers, pesticides and biotechnology along with the development of machines and equipment, have enabled the world's agribusinesses to collectively increase both the quality and quantity of crops produced for human consumption.

The dramatic transformation of plant production is not limited to food crops, but also includes dramatic developments in the horticultural industry and specifically with respect to the production of ornamental plants. In fact, over the past few decades, the incredible increase in demand for ornamental plants has made this segment of plant production one of the fasted growing and one of the most dynamic industries within plant production. Indeed, the business of producing ornamental plants is now a multi-billion dollar industry integrally supported by horticulturalists, botanists, geneticists, nurserymen, landscape architects, arborists, garden center operators, pest control specialists, and professional landscape services as well as sophisticated greenhouse constructions, mechanics and logistics to manage the production of millions of plants annually.

Generally, the commercial production of plants includes three main components: the grower, the wholesaler, and the retailer. As should be appreciated, each component of this overall system continues to develop to cost effectively deliver high volumes of quality ornamental crops to keep pace with demand. In particular, the production of young plants has changed dramatically in response to demand and competition. The practice of modern horticulture has shown a movement away from raising young plants in the field or under natural conditions and into production facilities, such as greenhouses staffed with horticulture experts with the ability to control the environment of the young plants year round. A significant portion of ornamental plants are now grown and later marketed in containers, including ornamental trees and shrubs, fruit trees and perennial flowers

Container production provides growers with the flexibility and ease of handling the young plant during production and shipment, and even takes up less acreage. In addition, growers are not confined to using the soil native to the location of the grower. Rather, a grower can use a selected growing media within each container suitable for a particular crop. Container production, however, requires tremendous vigilance by the grower to ensure proper water management and irrigation, nutrient management and weed management, compared to crops grown in the field.

Nurseries staffed with professional growers and horticulturalists are very capable of giving the young plants the attention they need during this critical time in their development. Once the plants leave this nurturing professional greenhouse environment and are transported to be sold, the ability to recreate the vigilance experienced at the grower levels is impractical. As a result, oftentimes plants are not watered enough and will show signs of severe drought stress, including wilt, yellowing, and loss of flowers. Prospective buyers, in turn, do not purchase plants that are poor in appearance, which in turn leads to reduced sales and loss of profits typically borne by the grower.

Over the years, there have been a variety of different concepts have been developed to assist in the water management of container plants, including watering devices, sub-irrigated planter boxes and “self-watering” plant containers. Other concepts include the use of water retaining membranes and superabsorbent polymers (SAPs). However, many of these systems and structures are quite complex and are not suitable or adaptable for use as part of the well-tuned practices that are in place at the grower level. Indeed, many of these solutions appear to be practical for consumers' enjoyment of the plants after they are purchased and transplanted in the backyard.

Efforts continue to develop new containerized plant systems so as to potentially improve the health and growth development of a plant while positioned within a containerized plant system, for example, while in a retail environment.

### SUMMARY

The present invention provides a solution that can be easily utilized at the grower level without impacting the advantages of container production, while addressing the longevity of the plant at the retailer level. The present invention is also versatile in that the consumer can opt to leave the plant within its container for continued enjoyment or subsequently transplant the plant into the ground or a different container.

Accordingly, the present invention is directed to containerized plant growing solution systems. In one exemplary embodiment, the containerized plant growing solution system comprises a container adapted to support plant growth and to be transportable, the container comprising a housing including a bottom wall and a solid surrounding sidewall extending upwardly therefrom to define a housing interior separated from an exterior environment and terminating in an upper rim thereby to define an opening; a divider transversely disposed in the housing interior in spaced relation to the bottom wall and oriented to separate the housing interior into a water reservoir therebelow and a plant and plant growing media thereabove, the divider constructed so as to prevent the passage of plant growing media into the water reservoir while permitting roots of a growing plant to extend therethrough and into the water reservoir; and at least one drainage aperture formed through the housing and in communication with the exterior environment and adapted to permit the release of excess water from the lower region.

In another exemplary embodiment, the containerized plant growing solution system comprises a container adapted to support plant growth, the container comprising a housing comprising a bottom wall and a solid surrounding sidewall extending upwardly therefrom to define a housing interior separated from an exterior environment and terminating in an upper rim thereby to define an opening; a divider assembly disposed in the housing interior in spaced relation to the bottom wall and oriented to separate the housing interior into a first lower region and a second upper region, the divider assembly comprising a permeable membrane, and an air permeable divider secured to the membrane; and at least one drainage aperture formed in the housing and in communication with the exterior environment.

In yet another exemplary embodiment, the containerized plant growing solution system comprises a container for growing and transporting plants, wherein the container comprises a housing comprising a bottom wall and a solid surrounding sidewall extending upwardly therefrom to define a housing interior separated from an exterior environment and terminating in an upper rim thereby to define an opening, the housing formed as a one-piece unitary construction; a divider assembly disposed in the housing interior and oriented to separate the housing interior into (i) a water reservoir located proximate the bottom wall and sized to hold an amount of a hydrated water-absorbing polymer, (ii) a plant growing chamber sized to receive and support the growth of at least one plant, and (iii) an air chamber interposed between the water reservoir and the plant growing chamber; wherein the divider assembly is constructed to permit roots of a growing plant to extend therethrough; and at least one drainage aperture formed in the housing and communicating between the water reservoir and the exterior environment.

The present invention is further directed to plant growing system. In one exemplary embodiment, the plant growing system comprises a water reservoir for holding water; a plant chamber for receiving and holding a plant starting material and plant growing media; and a ventilation chamber constructed of fibrous material interposed between the water reservoir and the plant chamber, wherein roots of the plant material are capable of extending through the fibrous material and into the water reservoir.

The present invention is further directed to dividers suitable for use in plant containers. In one exemplary embodiment, the divider of the present invention comprises (i) a permeable membrane having an outer membrane periphery, (ii) a divider sidewall extending downward from the outer membrane periphery, and (iii) a divider bottom wall joining the divider sidewall opposite the permeable membrane; the permeable membrane, divider sidewall and divider bottom wall surrounding a divider interior space sized so as to house an amount of hydrated water-absorbing polymeric material; and water-absorbent polymeric material positioned within the divider interior space.

The present invention is even further directed to methods of making containerized plant growing solution systems, containers, and dividers of the present invention, and methods of using containerized plant growing solution systems, containers, and dividers of the present invention. In one exemplary embodiment, the method of making a containerized plant growing solution system of the present invention comprises thermoforming a container housing having one or more features for supporting a divider therein, wherein the one or more features are selected from (i) a hollow support member extending upwardly from a bottom wall of the container housing and surrounding at least one drainage aperture within the bottom wall, (ii) a plurality of divider support members projecting into a container housing interior from an interior surface of a solid surrounding sidewall of the container housing, (iii) a ledge extending along at least a portion of a periphery of an interior surface of a solid surrounding sidewall of the container housing, or (iv) any combination of (i) to (iii).

In another exemplary embodiment, the method of making a container of the present invention comprises a method of preparing a transportable plant container to support a living plant, wherein the method comprises providing a plant container comprising three interior regions, the three interior regions comprising a lower water storing region, an upper plant receiving region, and an oxygen ventilation region therebetween; providing a channel extending from an upper rim of the plant container and along an inner surface of the plant container so as to be in fluid communication with the water storing region and the exterior environment; positioning a water-absorbent polymer in the water storing region; hydrating the water-absorbent polymer; positioning plant growing media in the upper region; and

positioning the plant in the growing media.

In one exemplary embodiment of making a divider suitable for use in plant containers, the method of making a divider comprises combining (i) a permeable membrane having an outer membrane periphery, (ii) a divider sidewall extending downward from the outer membrane periphery, and (iii) a divider bottom wall joining the divider sidewall opposite the permeable membrane so that the permeable membrane, divider sidewall and divider bottom wall surround a divider interior space sized so as to house an amount of hydrated water-absorbing polymeric material; and incorporating water-absorbent polymeric material within the divider interior space.

The present invention is further directed to methods of using any of the disclosed containers, dividers, and plant growing systems. In one exemplary embodiment, the method of using a containerized plant growing solution system of the present invention comprises a method of growing a plant or plant propagation material, wherein the method comprises positioning the plant or plant propagation material within any of the herein described containers; and adding water to the container. The disclosed methods of growing a plant or plant propagation material may further comprise a number of additional steps including, but not limited to, positioning the containerized plant growing solution system under a light source; incorporating one or more plant growing inputs (e.g., fertilizers, pesticides, fungicides, plant growth regulators, etc.) into the containerized plant growing solution system; removing the plant from the containerized plant growing solution system; planting the removed plant in the ground or a permanent plant-growing vessel; or any combination of one or more of the above steps.

These and other features and advantages of the present invention will become apparent after a review of the following detailed description of the disclosed embodiments and the appended claims.

### BRIEF DESCRIPTION OF THE DRAWINGS

FIG. 1 is a perspective view of a plant potted in a container as known in the art;

FIG. 2 is a cross-sectional view of the potted plant shown in FIG. 1;

FIG. 3 is an end view in perspective of a container commonly used for holding plants and growing media;

FIG. 4 is a cross-sectional view of an exemplary container according to the present invention showing a plant with roots growing in a growing media;

FIG. 5 shows the exemplary container of FIG. 4 with roots of the plant extending beyond the growing media, through a divider and into a water reservoir of the exemplary container;

FIG. 6 is a cross-sectional view of the exemplary container in FIG. 4 without the plant and its growing media;

FIG. 7 is an exploded top end view of exemplary components of the exemplary container shown in FIGS. 4-6;

FIG. 8 is an exploded top end view of exemplary components and features of another exemplary container of the present invention;

FIG. 9 is a cross-sectional view of the exemplary container shown in FIG. 8 with a plant potted therein;

FIG. 10 shows the exemplary container of FIG. 9 with roots of the plant extending beyond the growing media, through a divider and into a water reservoir of the exemplary container;

FIG. 11 shows an exemplary divider system, shown in an extended state, suitable for use in a conventional container for receiving and supporting a plant therein;

FIG. 12 shows the exemplary divider system of FIG. 11 in a collapsed state;

FIG. 13 shows the exemplary divider system of FIG. 11 in an extended state and in combination with a plant, plant growing media, and a conventional container;

FIG. 14 shown a cross-sectional view of the plant-growing system shown in FIG. 13;

FIG. 15 shows a cross-sectional view of the plant-growing system shown in FIG. 13 with roots of the plant extending beyond the growing media, through a divider and into a pouch of the exemplary divider system of FIG. 11;

FIG. 16 shows a cross-sectional view of another exemplary divider system of the present invention, wherein the exemplary divider system comprises a divider and a dish;

FIG. 17 shows the exemplary divider system of FIG. 16 in combination with a container for housing the exemplary divider system;

FIG. 18 shows an exploded top end view of exemplary components and features of another exemplary container of the present invention;

FIG. 19 shows a cross-sectional view of the exemplary container of FIG. 18;

FIG. 20 shows a view of another exemplary container of the present invention;

FIG. 21 shows an exploded top end view of exemplary components and features of the exemplary container of FIG. 20;

FIG. 22 shows a Table of experimental results as detailed in Example 2;

FIG. 23 shows a Table of experimental results as detailed in Example 2;

FIG. 24 shows a top perspective-view of an embodiment of the present invention;

FIG. 25 shows a side cross-sectional view of an embodiment of the present invention; and

FIG. 26 shows an exploded view of a water level indicator as described in the present invention.

### DETAILED DESCRIPTION OF THE EXEMPLARY EMBODIMENTS

As described above, container production is an extremely effective way for nursery growers to maximize the production of young plants and efficiently and conveniently transport those young plants for sale. Oftentimes, once these container grown plants leave the grower and are delivered to the retailer, the care of these plants deteriorates resulting in a plant that is no longer salable due to their poor appearance. The present invention relates to containers and growing systems that do not need to be watered or cared for as frequently as a plant supported within a traditional plant container.

While the preferred embodiments of the present invention offer a solution to the appearance and longevity of container plants while awaiting sale at the retailer, it will be readily appreciated that the benefits of reduced watering and care for the plants are also realized at the grower level and extend all the way through the retailer to the end consumer. Further, the container constructions and growing systems described herein are useful not only to commercial enterprises, such as those described above in the Background, but can be easily employed by hobbyists, experienced enthusiasts, and household plant owners.

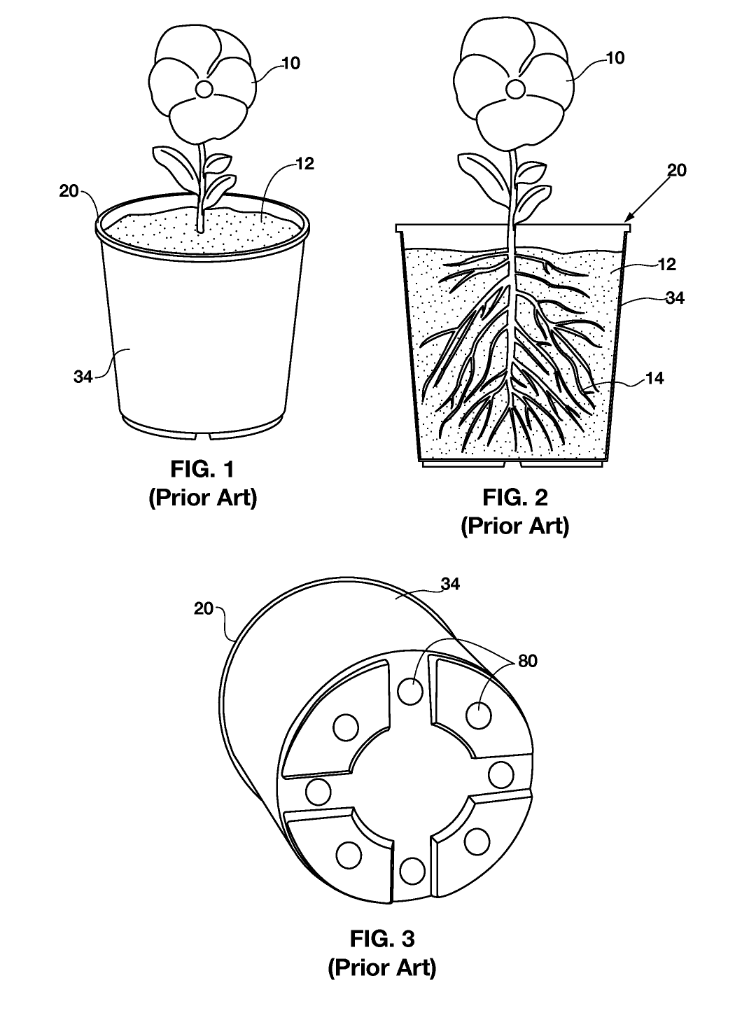

To best appreciate the exemplary embodiments of the present invention, it is perhaps first helpful to describe a conventional container construction and growing system. Turning first then to FIGS. 1-3, a typical container plant 10 is shown growing in selected growing media 12 and potted in container 20 having sidewall 34. Container 20 is shown as frustoconical in configuration, constructed of a lightweight plastic material, and is of the sort that is commonly used by growers for young plant production. Such plastic material could, for example, could comprise one or a combination of the following thermoforming plastics: polyethylene terephthalate, high density polyethylene, polyvinyl chloride, low density polyethylene, polypropylene, polystyrene, polypropylene, polystyrene, and polytetrafluoroethylene.

As plant 10 grows within this environment, roots 14 extend throughout and are nourished by growing media 12 and water that is provided from a water source (not shown) such as a hose, sprayer or gardening pail. Container 20 includes bottom wall 32, perhaps best shown in FIG. 3, with a plurality of drain apertures 80 formed therethrough to drain excess water out of the container.

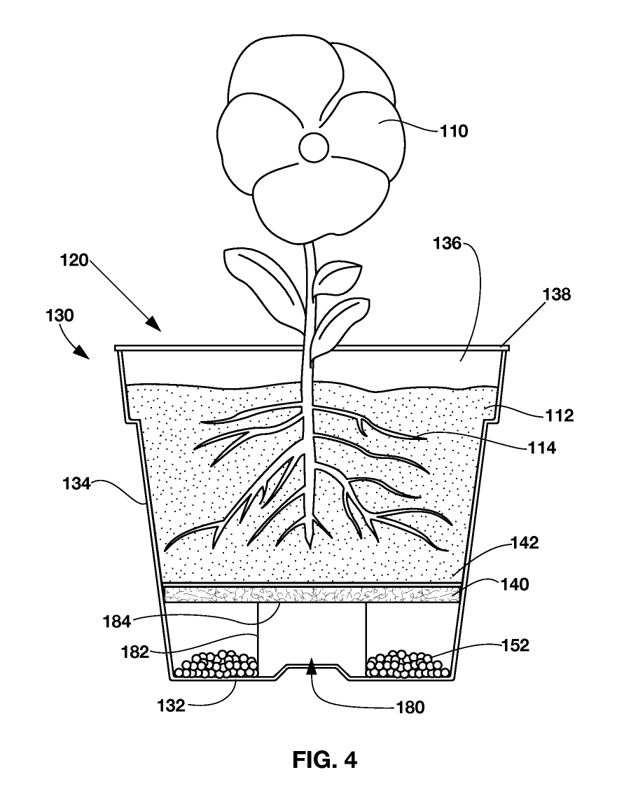

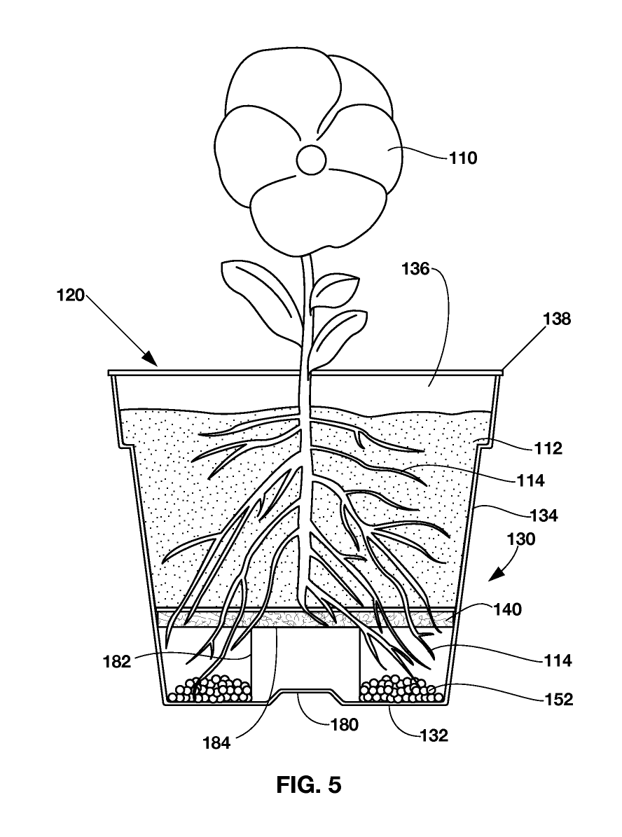

Turning next to FIGS. 4-5, plant 110 is shown growing in container 120 according to a first exemplary embodiment of the present invention. From the outside, container 120 appears visually similar to conventional container 20 described above. For example, container 120 is generally frustoconical in configuration and can also be constructed of the conventional lightweight plastic material readily employed by growers today. However, container 120 includes an internal structure that is entirely absent from the conventional container. The internal structure of container 120 improves the hydration and nourishment of plant 110, enabling plant 110 to be watered and cared for less frequently than the plant 10 growing in container 20.

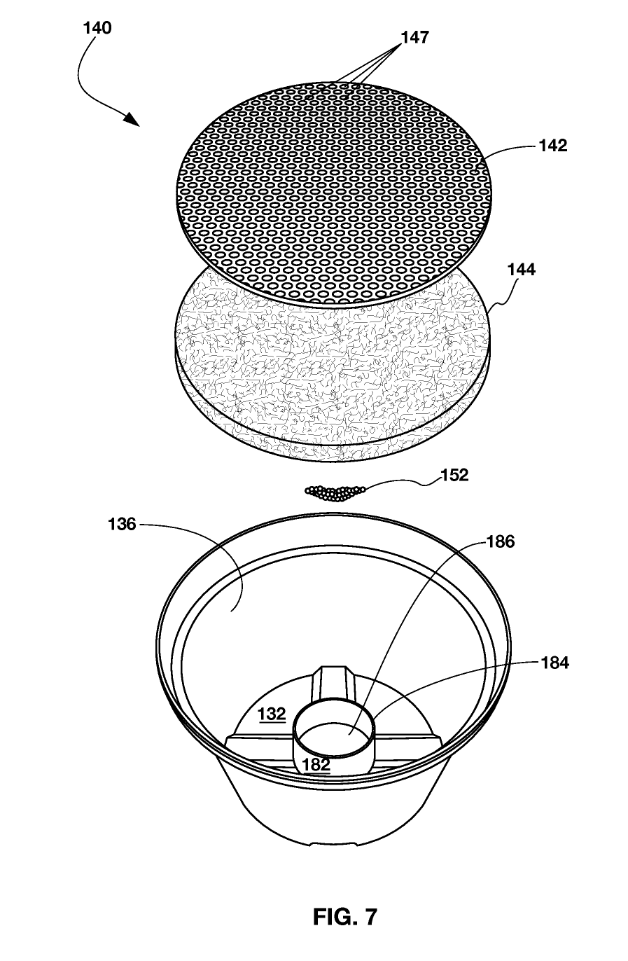

With continued reference to FIGS. 4-6, container 120 comprises housing 130, divider 140 and drainage aperture 180. Housing 130 includes bottom wall 132 and a solid surrounding sidewall 134 extending upwardly therefrom to define housing interior 136. Sidewall 134 terminates in upper rim 138 to define an opening that communicates between the interior and external environment. Drainage aperture 180 is formed and centrally located in bottom wall 132 and surrounded by hollow, elongated support column 182, which extends upwardly from bottom wall 132 to terminate in column opening 184. Column interior 186 communicates with the exterior environment via aperture 180, and as will be described in more detail below in reference to FIG. 7, excess water from the water reservoir and air exchange takes place within column interior 186. Support column 182 may be integrally formed as a unitary piece with bottom wall 132, or be a separate piece that is fitted about drainage aperture 180 in a snap fit engagement, a nestable state or other conventional means as well known in the art.

Divider 140 is transversely disposed in the housing interior 136 in spaced relation to bottom wall 132. In this particular embodiment, divider 140 separates or otherwise divides housing interior 136 into two regions, namely, lower region 150 and upper region 160. In this particular embodiment, the presence of divider 140 additional creates an air space in between these regions. The two interior regions 150, 160 and the construction of divider 140 will be described in more detail below, but generally, lower region 150 is located below divider 140 in the form of a water reservoir and upper region 160 is the plant chamber and receives both the plant 110 and the growing media 112. Air space or air chamber 170 serves as a buffer between the upper and lower regions and functions to facilitate the ventilation of housing interior 136. As plant 110 grows in container 120, roots 114 travel through growing media 112 in search of nourishment for the plant 110. Some roots 114 stay in region 160 while some roots 114 travel into and through divider 140 and are present in air space 170 and below within water reservoir 150 as shown in FIG. 5.

Water reservoir 150 has been provided with a suitable amount of water-absorbing polymers 152, shown in FIGS. 4-6 prior to hydration. Water-absorbing polymers 152 are well known in the art and can be more specifically described as environmentally safe polyacrylamide crystals that are capable of absorbing 300 times or more of its weight in water. Suitable water-absorbing polymers for use in water reservoir 150 include those commonly described in the art as superabsorbent polymers such as cross-linked copolymers of acrylamides and acrylates. Commercially available superabsorbent materials suitable for use in the present invention include, but are not limited to, STOCKOSORB® XL (Evonik Stockhausen, Krefeld, Germany), which is a crosslinked acrylamide/acrylic acid copolymer, potassium salt, having an average particle size of from about 2 to about 4 millimeters (mm) when dry, and an average particle size of from about 18 to about 26 mm when fully hydrated in distilled water. However, suitable water absorbing polymers do not need to be limited to those described above. Rather, water absorbing polymers contemplated for this invention may also include alkyl polyglucosides and their esters; ligins; AgRho Guar Gum, and starch bases.

Once hydrated with water, these water-absorbing polymers 152 form a relatively thick gel in a period of about one to two hours. The gel is able to gradually release the absorbed water, and can significantly reduce the frequency of watering the plants. In addition to releasing water, these water absorbing polymers 152 can also release a variety of other selected ingredients that assist in the growth and health of the plant. For example, nutrients that can be added to the water-absorbing polymers 152 in the water reservoir include, but are not limited to, one or more of: fertilizers, controlled release fertilizers, plant growth regulators, plant protection materials, fungicides, insecticides, and any combination thereof. Suitable fertilizers include, but are not limited to, inorganic fertilizers such as controlled release fertilizers, slow release fertilizers, and water-soluble fertilizers; and organic fertilizers such as guano, bone and fish meal, worm castings, compost and vegetable extracts, humic acids, etc.

Suitable plant growth regulators and plant protection materials include, but are not limited to, plant growth regulators in the form of any chemical compound that alters the growth and development of plants such as auxins, gibberellins, cytokinins, etc.; compounds that induce plant resistance mechanisms (e.g. salycilic acid and jasmonates); pesticides including compounds that have a direct effect on insects causing death, or affect their metabolism (e.g. growth regulators); biological control agents including any species of fungi, bacteria or insect that is able to control pests and/or organisms that cause a disease of a plant; and plant enhancement compounds such as 24-epibrassinolide; rhodia guar gum, topolin, strigolactones; and disodum cocopolyglucose sulfosuccinate.

It should be noted that any of the above-mentioned exemplary materials (e.g., plant nutrients; fertilizers; controlled release fertilizers; plant growth regulators; plant protection materials; fungicides; insecticides; compounds that induce plant resistance mechanisms; pesticides; and biological control agents) alone or in combination may be incorporated into the potted plant systems of the present invention.

With continued reference to FIGS. 4-6, upper region 160 is the plant chamber and generally the area within housing interior 136 where plant growing media 112 and a selected plant 110 are disposed or potted. As shown, singular plant 110 is shown potted in container 120, in plant growing media 112. Divider 140 supports both plant 110 and plant growing media 112 within housing 130.

Suitable plant-growing media may include, but is not limited to, soil, plastic beads, synthetic sponge material, expanded perlite, expanded vermiculite, peat moss, or any combination thereof. Further, a singular plant is shown here for exemplary purposes, and it should be readily appreciated that housing 130 can be of any suitable size or shape to accommodate any number or arrangement of plants and that the utility of the present invention is not limited to the construction shown in the figures. For example, the concepts described herein are readily adaptable to larger more permanent containers that are commonly used in backyard gardens, as well as for indoor houseplants, such as hanging baskets.

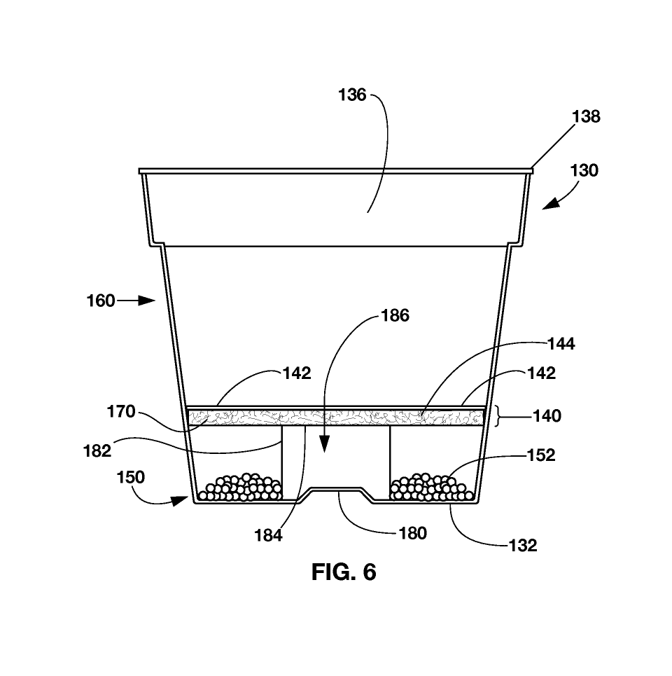

Reference is now made to FIGS. 6 and 7 to describe the construction and function of divider 140. Divider 140 is shown here as being constructed as a flat disc having a configuration that is complementary to the shape of housing sidewall 134. When disposed within housing 130, divider 140 is set transversely upon support column 182 in spaced relation to bottom wall 132. In this embodiment, divider 140 is an assembly of two similarly shaped co-extensive elements, namely, permeable membrane 142 and fibrous material 144, which are preferably secured together by appropriate means such as glue or other bonding agent known in the art. Fibrous material 144 creates air space 170.

As shown in FIGS. 4 and 5, divider 140 obstructs the passage of plant growing material 112 from seeping into water reservoir 150. In addition divider 140 acts as a buffer or separator so that regions 150 and 160 are spaced apart from one another. In this way, water in the water reservoir is conserved in two ways: (1) water does not permeate directly into the plant growing media itself; and (2) divider 140 acts as an evaporative shield to prevent water loss through the plant growing media. Accordingly, divider 140 is constructed to conserve as much water as possible for uptake and use by the plant roots.

Permeable membrane 142 is shown in the figures as being locatable on top of fibrous material 144 so as to serve as the floor for the plant and plant growing media. However, the arrangement of these two elements is not limited this way, and the construction of divider 140 will also function in the manner it is intended when fibrous material 144 serves as the floor for the plant and plant growing media and permeable membrane 142 is the ceiling for the water reservoir 150.

Permeable membrane 142 can be of any suitable construction that provides support and stability to divider 140 to keep the water reservoir 150 separate from plant growing chamber 160 and permit roots to grow therethrough. In the figures referenced, permeable membrane 142 is constructed as a thin, flat plastic membrane with a plurality of apertures 147 formed therein to permit the roots of the growing plant to extend therethrough. See, for example, FIG. 7. However, permeable membrane 142 is not limited to this construction and may comprise other suitable membranes including, but not limited to, microporous permeable membranes such as, for example, DuPont TYVEK® house wrap or semi-permeable membranes commercially available from Spectrum Labs under the trade designation SPECTRA/POR™.

Fibrous material 144 can be any synthetic or natural material that can create air space 170 between regions 150, 160 and that is porous to water but not solids. Examples of suitable fibrous materials 144 include, but are not limited to, nonwoven fabrics comprising cellulosic fibers, fiberglass fibers, synthetic polymeric fibers (e.g., polypropylene, polyethylene, etc.), or any combination thereof. Examples of suitable commercially available fibrous materials 144 include, but are not limited to, a household furnace filter material sold under the trade designation PRECISIONAIRE KK500 “Cut-'N-Fit” Polyester Washable Air. A suitable biodegradable material could be, for example, DelStar Technologies, Inc. DELPORE™ meltblown filter media described at http://www.filtsep.com/view/1869/delstar-develops-sustainable-meltblown-filter-media/. In addition, if desired, fibrous material 144 can be impregnated with one or more of: fertilizers, controlled release fertilizers, plant growth regulators, plant protection materials, fungicides, insecticides, and any combination thereof, which have been more fully described above.

Now that the assembly of divider 140 has been described in some detail, its interaction with support column 182 and as a component of the overall container 120 can be better appreciated. When container 120 is fully assembled, such as shown in FIGS. 4 and 5, and water absorbent polymers 152 are hydrated (not shown), the maximum amount of water available to the water reservoir 150 depends upon the height of support column 182. As the water rises above the height of support column 182, excess water spills into column interior 186 and is expelled from container 120 and into the external environment via drainage aperture 180. Since fibrous material 144 is preferably porous to water, it should be appreciated that at least some water vapor or moisture will reside in air space 170.

The release of excess water through support column 182 helps keep air space 170 intact and creates a supply of oxygen available within housing interior 136, which is very advantageous to root growth. Oxygen can continually be introduced to container 120 via drain aperture 180, which is in direct contact with air space 170. In this way, oxygen can then move through the system freely and be refreshed via gas exchange for acceptable root growth. Fibrous material 144 provides the ability to store oxygen enabling roots 114 that extend therein to absorb oxygen, as well as nutrients and water. Water uptake can be sourced from liquid water in the reservoir, water made available within the water absorbent polymers, or even water vapor, which exists in the air space 170.

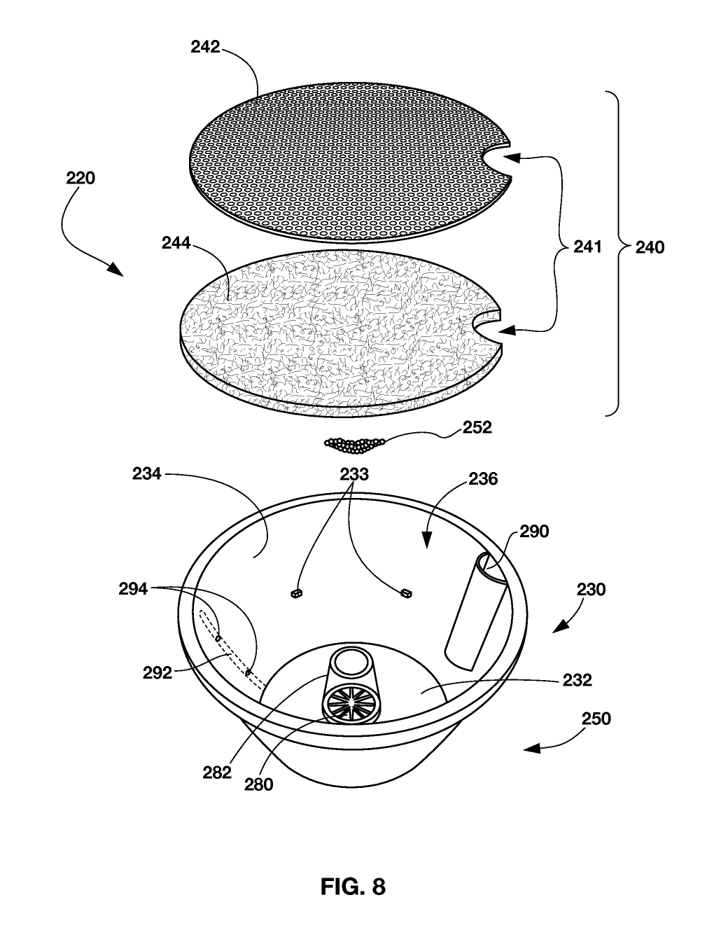

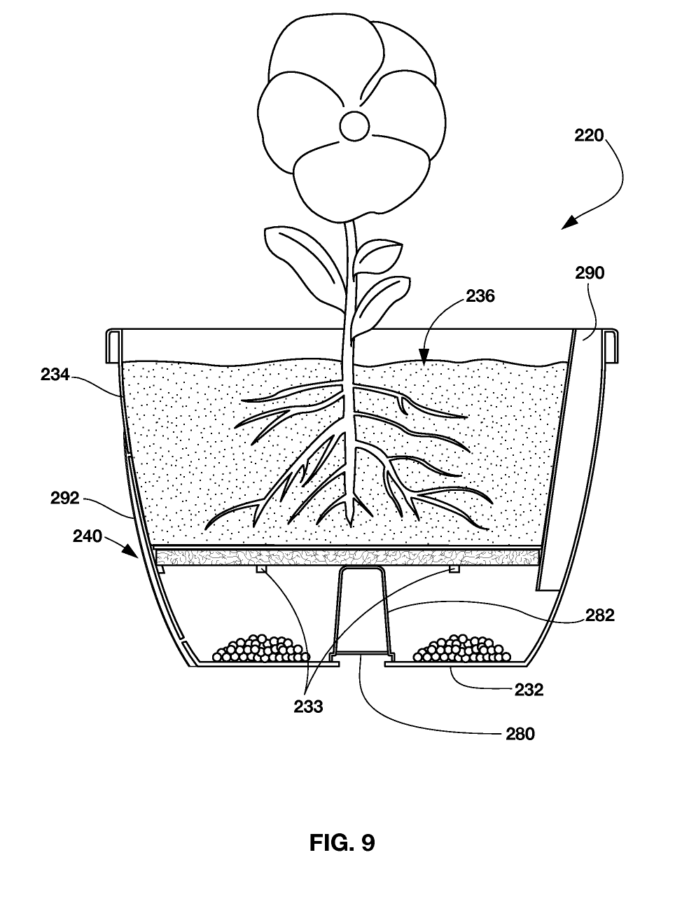

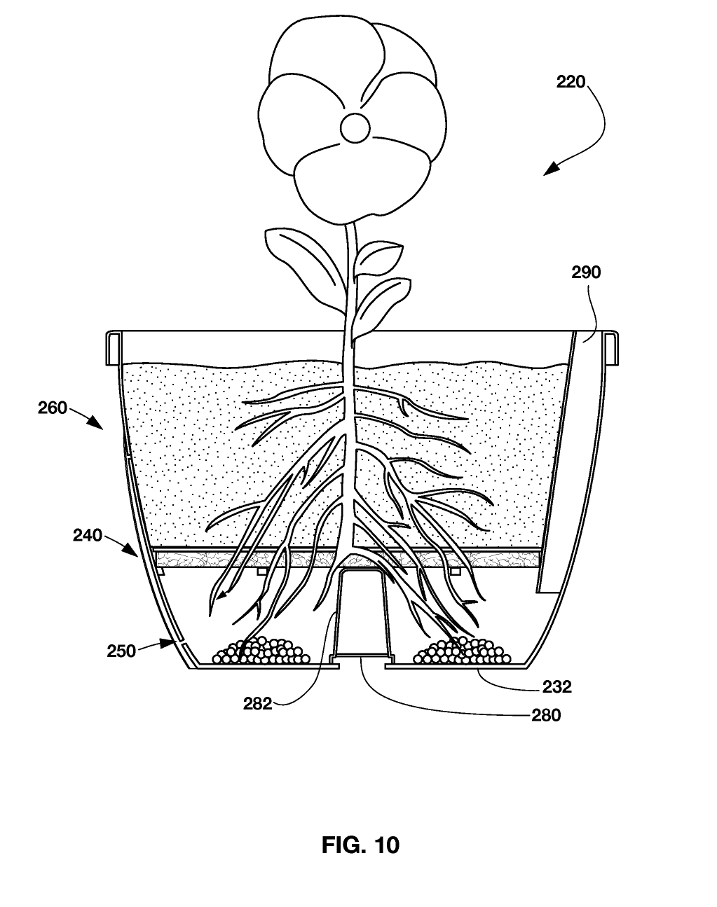

A second exemplary embodiment of the present invention is shown in FIGS. 8-10, wherein container 220 includes housing 230 having bottom wall 232 and a surrounding sidewall 234 extending upwardly therefrom to define housing interior 234. Divider 240 includes permeable membrane 242 and fibrous material 244, which is adapted to be disposed in housing interior 236 and separate housing interior 236 into water reservoir 250, plant growing chamber 260, and air space 270 therebetween. See, for example, FIGS. 9-10. Support column 282 extends upwardly from bottom wall 232 to (i) surround drain aperture 280 and (ii) support divider 240 when container 220 is in an assembled state. Here, support column 282 is configured to permit stacking of a similarly constructed improved container 220.

Container 220 additionally includes a plurality of divider support members 233 projecting from sidewall 234 and into housing interior 236. Divider support members 233 are adapted to support divider 240, along with support column 282, when disposed in the housing interior. Container 220 is further provided with conduit 290 and window 292. Conduit 290 is shown here as being supported by surrounding sidewall 234 and adapted to receive water from a water source (not shown) for direct hydration of water absorbing polymers 252 (which may or may not be utilized, depending on the embodiment) seated within water reservoir 250. Divider 240 is provided with cut-out section 241 to accommodate conduit 290.

Window 292 is formed in sidewall 234 and is operative to provide visibility into housing interior 236 when container 220 is fully assembled and a plant and plant growing media are disposed therein. Window 292 is particularly suited to enable an individual to observe the water level within water reservoir 250. Graduations 294 may further be provided to assist the individual in approximating when to re-hydrate the water reservoir 250. Any combination of divider support members 233, conduit 290, and/or window 292 may be adaptable for use in connection with other containers of the present invention including, for example, container 120 shown and described above.

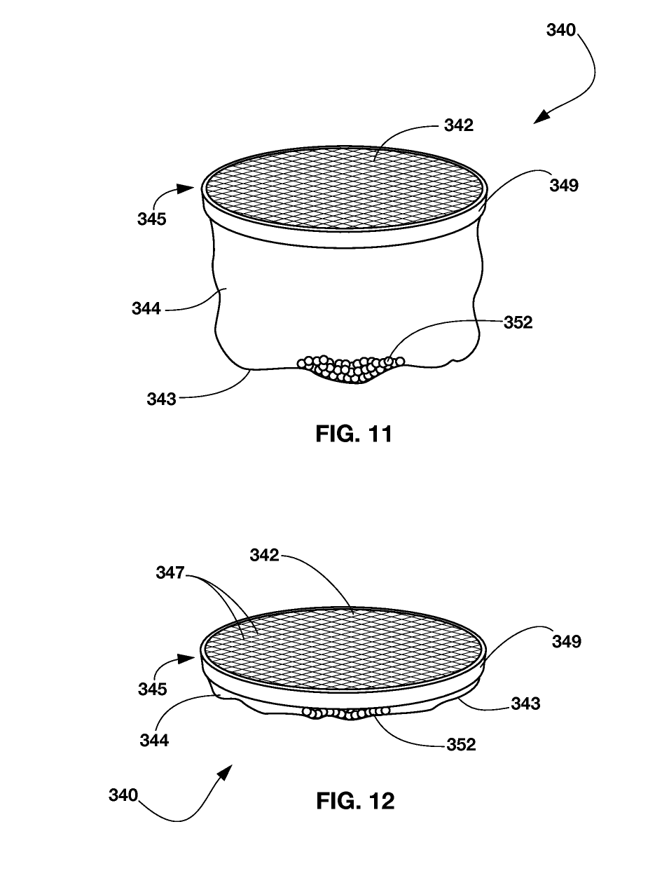

With reference now to FIGS. 11-12, another embodiment of the present invention comprises a divider that can be used to improve a conventional container for receiving and supporting a plant therein. Divider 340 of the present invention is shown in FIGS. 11-12 to include annular ring 345 and permeable membrane 342 extending therearound. Permeable membrane 342 is shown as a screen mesh with a plurality of apertures 347. Divider 340 further includes pouch 344, having lower surface 343, attached to annular ring 345 and capable of receiving and holding a suitable amount of water-absorbing polymers 352, which can also include a mixture of one or more of: fertilizers, controlled release fertilizers, plant growth regulators, plant protection materials, fungicides, insecticides, and any combination thereof. Pouch 344 may be formed from a water-permeable material, an air-permeable material, both a water- and air-permeable material, or a water- and air-impermeable material. Suitable materials for forming pouch 344 may include, but are not limited to polypropylene, polyethylene, cellophane, corn starch, polylactic acid (PLA), polyethylene terephthalate (PET), oriented polystyrene (OPS) and polyvinyl chloride (PVC), cellulose ester (CE), regenerated cellulose (RC), flashspun high-density polyethylene fibers (flashspun HPDE), as well as biodegradable material such as starch based polylactic acid or other mixed or composite material.

Divider 340 is movable between an extended state, shown in FIG. 11 and a collapsed state shown in FIG. 12. Collapsing divider 340 makes efficient use of space for the convenience of packaging or marketing divider 340 separately from a container.

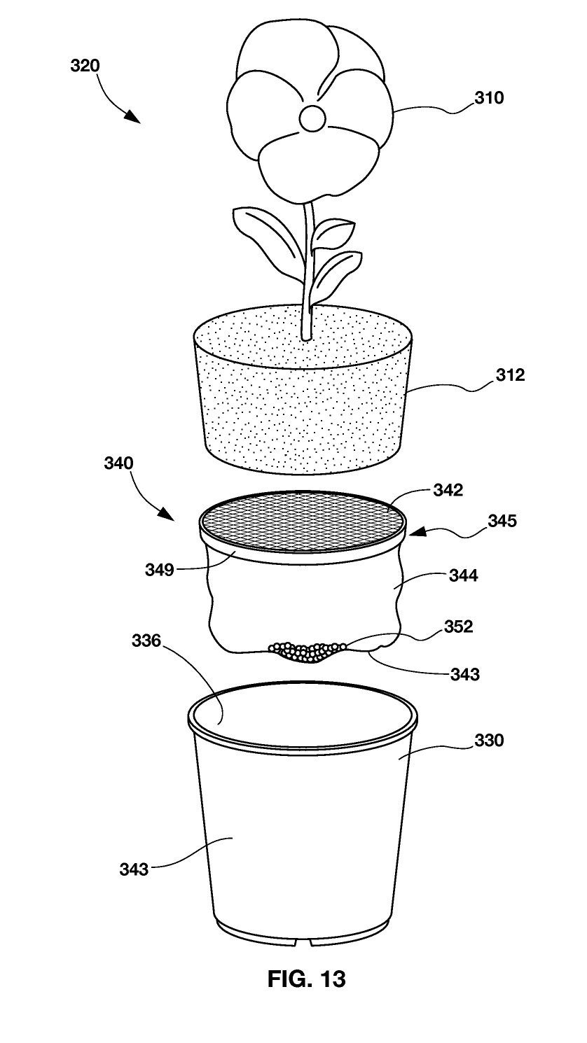

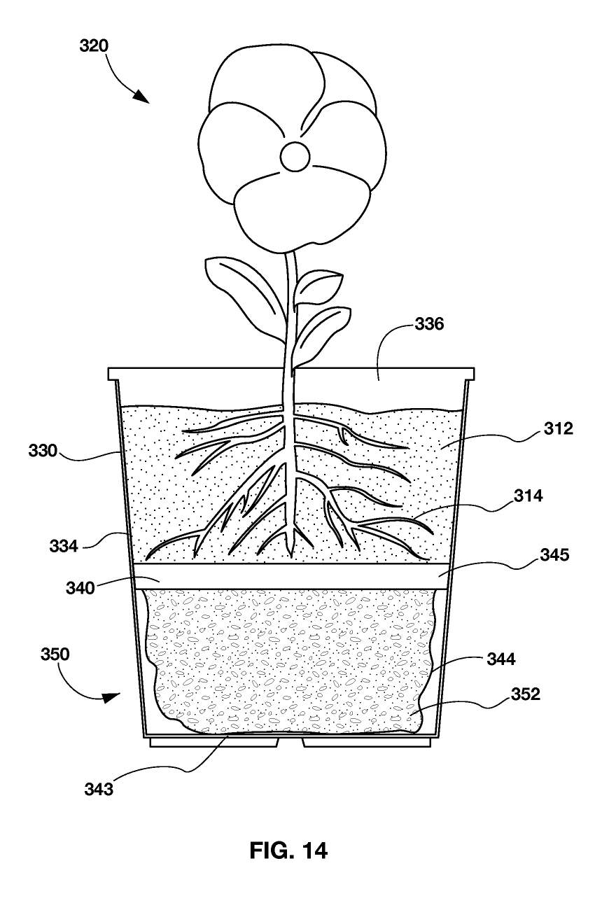

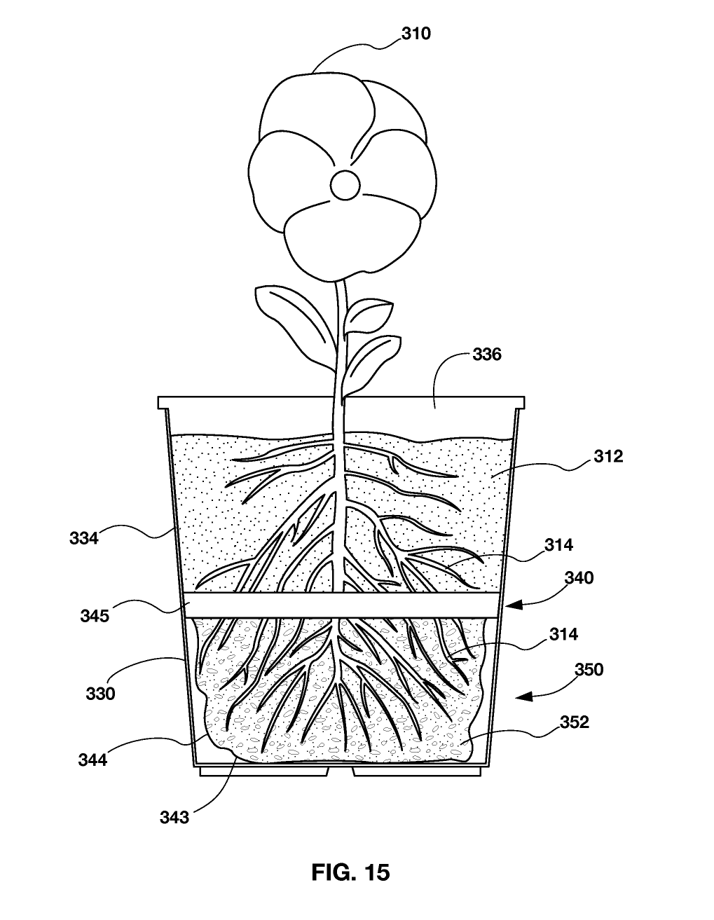

With continued reference to FIGS. 11-12 and additional reference to FIGS. 13-15, divider 340 is sized and adapted to be disposed circumferentially about and supported by housing interior 336 such that the outer peripheral surface 349 of annular ring 345 is in sufficient contact with surrounding sidewall 334 of container 310 to be supported thereby. See, for example, FIGS. 14-15. When fully assembled, divider 340 divides housing interior 336 into lower water reservoir region 350 and upper plant growing region 360. The water reservoir 350 is defined by pouch 344, which nests within lower water reservoir region 350 of housing 330. Permeable membrane 342 (i) supports plant growing region 360 and (ii) has apertures 347 sized and adapted to permit growth of roots 314 therethrough, while supporting plant 310 and growing media 312 above.

Divider 340 is shown in FIGS. 11-15 without the use of fibrous material to create an air space between water reservoir 350 and upper region 360. However, a suitable amount of fibrous material with the appropriate configuration could be added to divider 340 (e.g., positioned above or below, and optionally attached to, permeable membrane 342) such that container 320 could be provided with an airspace as discussed above (e.g., airspace or air chamber 170).

Although not shown in FIGS. 13-15, divider 340 may be supported within container 330 via any of the above-described supports including, but not limited to, support column 182/282, divider support members 233, or any combinations thereof.

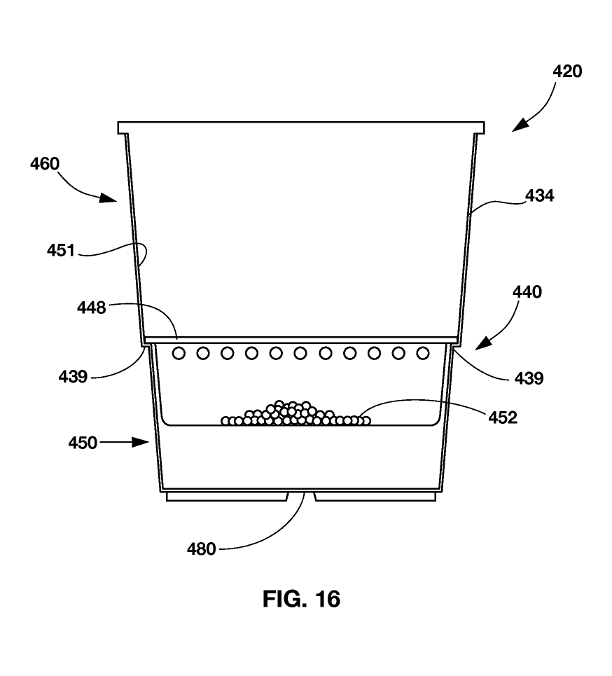

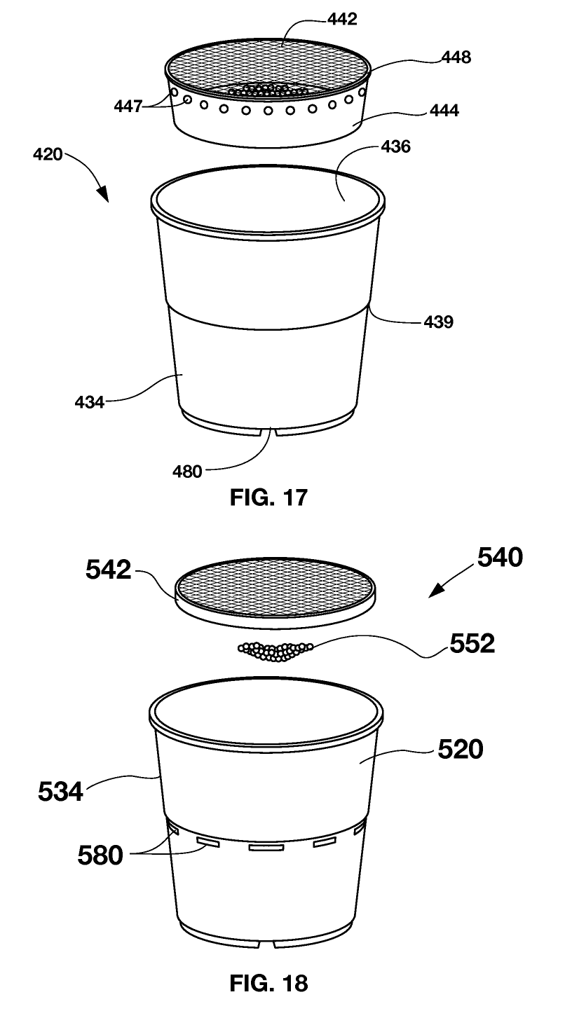

FIGS. 16 and 17 show yet a different divider of the present invention, namely, divider assembly 440 that can be used to improve a conventional container for potted plants. Here, divider 440 includes dish 444 sized and adapted to nest within housing interior 436 and receive a suitable amount of water-absorbing polymer 452. Permeable membrane 442 extends across the mouth 448 of dish 444 so as to support a plant and plant growing media thereabove when container 420 is fully assembled. Dish 444 becomes the water reservoir for the potted plant, which is available to the roots of the plant once they extend through permeable membrane 442. Dish 444 further includes apertures 447, which permits the drainage of excess water to be expelled out of dish 444 and into lower region 450 and into the exterior environment through drainage aperture 480.

Dish 444 may be formed from a water-permeable material, an air-permeable material, both a water- and air-permeable material, or a water- and air-impermeable material. Suitable materials for forming dish 444 may include, but are not limited to, polypropylene, polyethylene, cellophane, corn starch, polylactic acid (PLA), polyethylene terephthalate (PET), oriented polystyrene (OPS) and polyvinyl chloride (PVC), cellulose ester (CE), regenerated cellulose (RC), flashspun high-density polyethylene fibers (flashspun HPDE), as well as biodegradable material such as starch based polylactic acid or other mixed or composite material. Typically, dish 444 is formed from a water- and air-impermeable material polymeric material such as polypropylene or polyethylene.

Similar to divider 340 shown in FIGS. 11-15, divider 440 is shown without the use of fibrous material between water reservoir 450 and upper region 460. However, a suitable amount of fibrous material with the appropriate configuration could be added to divider 440 (e.g., positioned above or below, and optionally attached to, permeable membrane 442).

As shown in FIGS. 16-17, container 420 may have a sidewall 434 having a sidewall ledge 439 extending along at least a portion of a periphery of inner surface 451. Although not shown in FIGS. 16-17, divider 440 may be supported within container 420 via ledge 439, as shown, or alternatively or in addition, may be supported by any of the above-described supports including, but not limited to, support column 182/282, divider support members 233, or any combinations thereof.

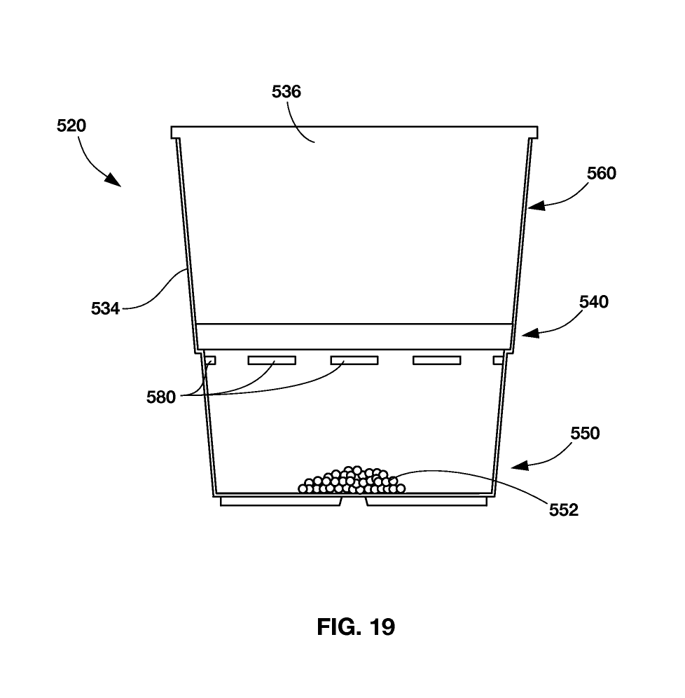

FIGS. 18 and 19 show another container construction using yet another divider assembly of the present invention. Here, divider assembly 540 is constructed similarly to that described above with reference to FIGS. 11-12 but without pouch 344. When nested within container 520, annular ring outer peripheral surface 549 of annular ring 545 is in sufficient contact with surrounding sidewall 534 of container 520 to be supported thereby. When fully assembled, divider 540 divides housing interior 536 into lower region 550 and an upper plant growing region 560. Absent the pouch described above, lower region 550 serves as the water reservoir for container 520 and is adapted to receive a suitable amount of water-absorbing polymer 552, which is hydrated by a water source (not shown).

Instead of a single drainage aperture formed in the bottom wall of the housing, container 520 is provided with at least one, and preferably a plurality of drainage apertures 580 formed in surrounding sidewall 534, which are located proximate to and below the location of divider 540 when nested and supported within housing interior 536. Drainage apertures 582 communicate with water reservoir 550 so that excess water is expelled therefrom at a location proximate to divider 540. Drainage apertures 580 can be located to create an air space between permeable membrane 542 and water reservoir 550, the advantages of which are fully described above.

Similar to divider 340 shown in FIGS. 11-15, divider 540 is shown without the use of fibrous material between water reservoir 550 and upper region 560. However, a suitable amount of fibrous material with the appropriate configuration could be added to divider 540 (e.g., positioned above or below, and optionally attached to, permeable membrane 542).

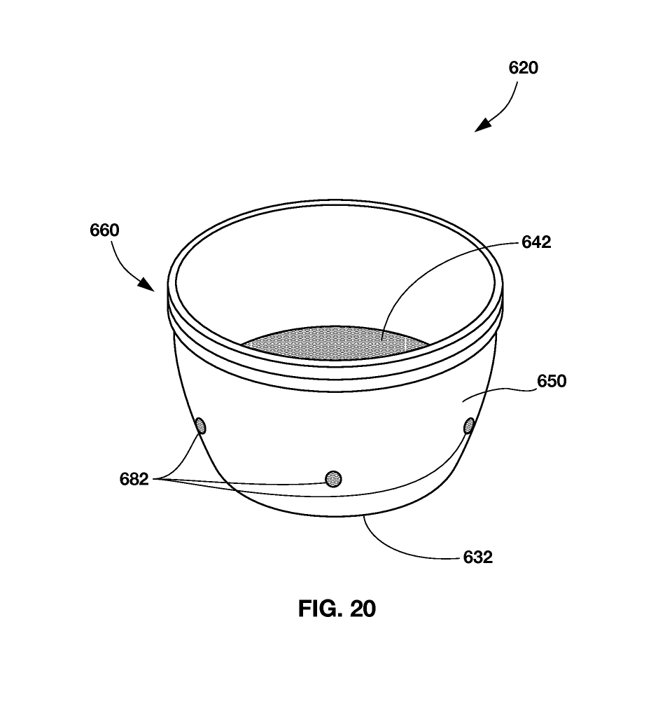

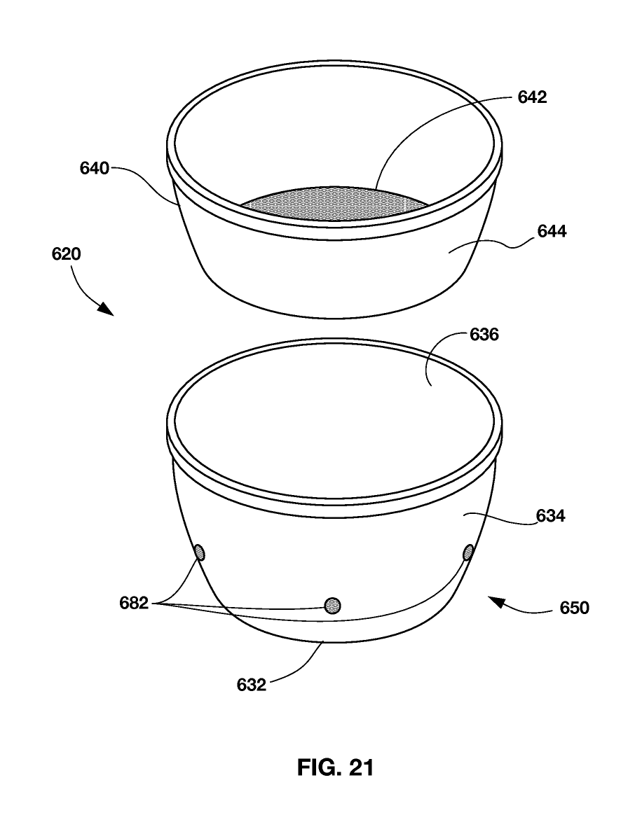

Finally, with reference to FIGS. 20-21, an improved hanging basket container 620 is shown wherein divider 640 is constructed as a dish 644 that is nestable within housing interior 636. Permeable membrane 642 extends across the bottom portion of dish 644 as a permeable bottom wall therefor. When divider 640 is disposed in housing interior 636 and supported by surrounding sidewall 634, it divides housing interior into a lower region 650 and an upper region 660 wherein lower region 650 becomes the water reservoir and dish 644, which is located in upper region 660, becomes the plant growing chamber adapted to receive the plant and plant growing media therein. Drainage apertures 682 formed in sidewall 634 are located proximate to and below permeable membrane 642 such that excess water in water reservoir 650 may be released therefrom to the external environment at a location below the membrane. In this way, bottom wall 632 is solid, having no drainage apertures formed therein.

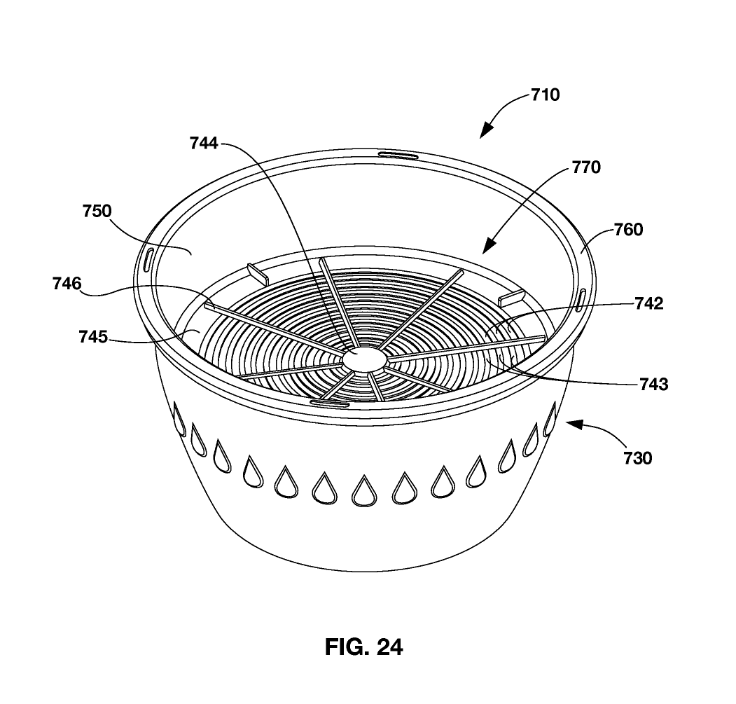

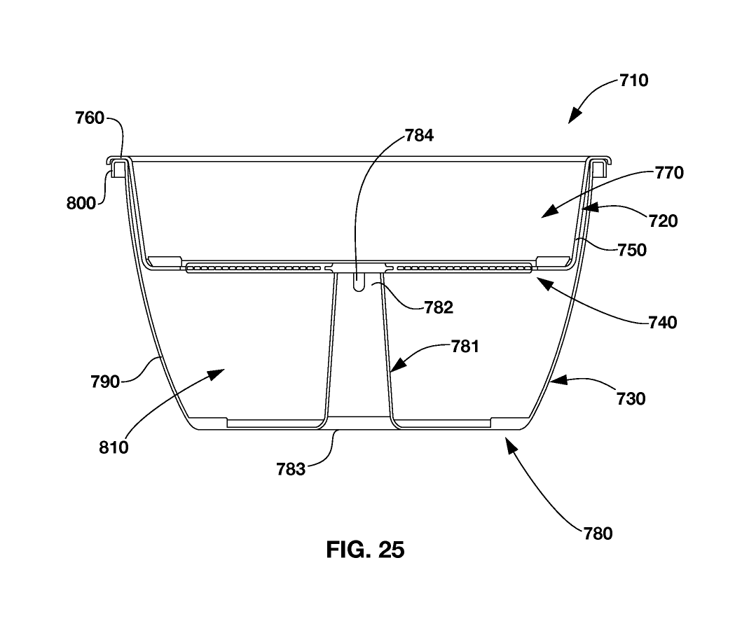

FIGS. 24 and 25 illustrate additional embodiments of the container of the present invention. As shown in the figures, container 710 includes a first chamber 720 and a second chamber 730. As shown in the figures, second chamber 730 is of a greater volume than first chamber 720 such that first chamber 720 may be situated within second chamber 730. As illustrated in FIG. 25, first chamber 720 includes a bottom surface 740 that extends upward to a sidewall 750 and that concludes on an upper rim 760. The construction of first chamber 720 creates an open area 770 between bottom surface 740 and upper rim 760 such that soil or other growing material (plant, flower, etc.), may be placed within open area 770 and may be contained by bottom surface 740 and sidewall 750.

First and second chambers 720 and 730, respectively, may be sized in any manner to meet the specifications of the user. For example, container 710 may be utilized for hanging baskets, patio planters, window boxes, railing planters, rolling planters, vegetable boxes and planters, trough planters, urns, barrels, buckets, vertical and wall planters, nursery pots, fountain planters, terrariums, bonsai planters, and multi-celled pots and planters, as well as other uses. To meet the uses determined by the user, first chamber 720 may be sized such that it contains a volume less than about 90% of the volume of second chamber 730. In other embodiments, first chamber 720 may be sized to be less than about 80%, 75%, 70%, 65%, 60%, 55%, 50%, 45%, 40%, 35%, 30%, 25%, 20%, 15%, 10%, or 5% of the volume of the second chamber 730.

As illustrated in FIG. 24, first chamber bottom surface 740 may include a series of apertures 741 that allows for an exit to first chamber 720. As further shown in FIG. 24, the series of apertures 741 is constructed in a concentric circle, with alternating apertures 742 and alternating closures 743 that include a center closure 744 and an outer closure 745. In some embodiments, first chamber bottom surface 740 may also include support slats 746 that extend from outer closure 745 to center closure 744. In such embodiments, support slats 746 may be utilized to maintain the positioning of alternating closures 743 along first chamber bottom surface 740.

Although the series of apertures 741 is illustrated in a concentric circle, it should be noted that the series of apertures 741 does not need to be constructed in the manner illustrated in FIG. 24. For example, in some embodiments, alternating apertures 742 may be constructed as a number of voided circles or other voided geometric shapes that are fit between a center closure and an outer closure. In addition, although the alternating apertures 742 have been shown in a pattern, in other embodiments, they may be done in a random order with varying sizes.

As discussed further below, alternating apertures 742 are constructed such that limited amounts of growing materials, including soil, are allowed to exit first chamber 720. For example, in embodiments of the present invention, alternating apertures 742 may each have a width or surface area of less than about 5 centimeters (cm). In other embodiments, alternating apertures 742 may each have a width or surface area of less than about 3 cm, 2 cm, 1 cm, 0.5 cm, 0.25 cm, 0.1 cm, 0.05 cm, 0.025 cm, 0.01 cm, 0.005 cm, 0.0025 cm, 0.001 cm, 0.0005 cm, 0.00025 cm, 0.0001 cm, or less, depending on the embodiment. Again, the user's specification will dictate the sizing needed.

The size of center closure 744 and outer closure 745 may also vary based on the user's specification. For example, center closure 744 and outer closure 745 may account for less than 10% of the total surface area of first chamber bottom surface 740. In additional embodiments, center closure 744 and outer closure 745 may account for less than 20%, 30%, 40%, 50%, 60%, 70%, 80% or more of the total surface area of first chamber bottom surface 740.

As further illustrated in FIG. 25, second chamber 730 includes a bottom surface 780 that extends upward to a sidewall 790 and that concludes on an upper rim 800. In some embodiments, and as shown in FIG. 25, first chamber upper rim 760 may be sized such that it may be supported by its placement over second chamber upper rim 800. As further illustrated, such configuration of first chamber upper rim 760 and second chamber upper rim 800 allow for first chamber to be suspended within second chamber 730 and create a water reservoir 810 that remains within second chamber 730.

As shown in FIG. 25, second chamber bottom surface 780 extends upward to form a tubular portion 781 with a first end 782 and a second end 783. In some embodiments and as shown in the figure, tubular portion 781 may extend upwardly such that tubular portion first end 782 contacts center closure 744 of first chamber bottom surface 740. In such configurations, first chamber upper rim 760 may not rest atop second chamber upper rim 800, as support may be provided by tubular portion 781. Conversely, if first chamber upper rim 760 is supported atop second chamber upper rim 800 then, in some embodiments, tubular portion first end 782 may not contact center closure 744.

Tubular portion 781 may be hollow between first end 782 and second end 783, where tubular portion second end 783 may provide an exit to the outside of container 710. Tubular portion 781 may also include at least one tubular opening 784 at tubular portion first end 782. As shown in FIG. 25, tubular portion 781 may include any number of tubular openings 784 to allow passage from water reservoir 810 into tubular portion 781. For example in some embodiments, one, two, three, four or more tubular openings 784 may be utilized.

In some embodiments of the invention, container 710 may include a filter to aid in the growth of the plant, flower or other material. In embodiments utilizing a filter, the filter may be placed underneath first chamber bottom surface 740 and remain within water reservoir 810 when first chamber 720 is placed inside second chamber 730. The filter may be positioned adjacent series of apertures 741 by adhesion to first chamber bottom surface 740 or by positioning the filter next to the series of apertures 741. The filter may also be constructed, in some embodiments, in a similar fashion to series of apertures 741 in a concentric circle allowing for tubular portion first end 782 to fit within a center portion of the filter. The filter may fill as much of the volume of water reservoir 810 as desired by the user. For example, the filter may fill less than 10% of the water reservoir 810 when first chamber 720 is placed within second chamber 730. In other embodiments, the filter may fill less than 20%, 30%, 40%, 50%, 60%, 70%, 80%, 90%, or more of the water reservoir 810 when first chamber 720 is placed within second chamber 730.

In certain embodiments, the filter may include a porosity of less than 10% air space. In other embodiments, filter may include a porosity of less than 20%, 30%, 40%, 50%, 60%, 70%, 80%, 90%, or more air space. Such filters may be constructed from suitable materials to meet the user's specifications. For example, non-limiting materials for use in the present invention include: synthetic polymers (polyurethane, polypropylene, nylon, polyolefins, polyester, etc.), metal mesh (copper, brass, aluminum, etc.), porous materials (clay, ceramic, rock wool, aggregated sand, stones, etc.) and natural fibers (cotton, hemp, kenaf, coconut, straw, etc.). In addition, other materials may also be utilized.

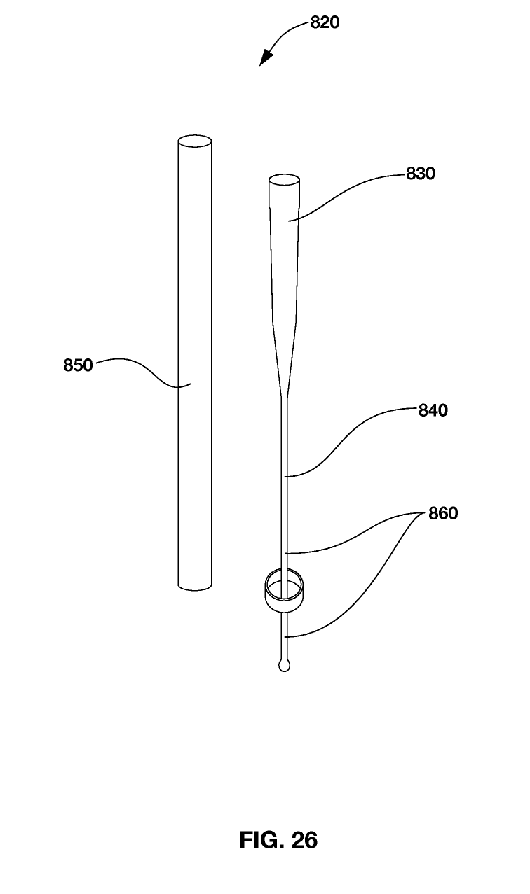

Container 710 may further include a water level indicator 820 that allows a user to determine an amount of water in water reservoir 810 when first chamber 720 is situated within second chamber 730. In some embodiments, water level indicator 820 may be structured as shown in FIG. 26. In such embodiments, water level indicator 820 may include a cylindrical portion 830 attached to an inner tube 840, which are moveably situated within an outer tube 850. Water level indicator 820 is then placed within container 710 such that outer tube 850 is immobily positioned in both open area 770 and water reservoir 810 through first chamber bottom surface 740. Cylindrical portion 830 is moveably positioned within outer tube 850 and in water reservoir 810 and inner tube 840 extends upwards to open area 770. Inner tube 840 may include markings 860 at desired locations that indicates, based on the displacement of cylindrical portion 830 by water in water reservoir 810, to the user the amount of water that is contained within water reservoir 810 by moving inner tube 840 either up or down within the immobile outer tube 750.

In operation, first chamber 720 is placed within second chamber 730. As discussed above, first chamber 720 may remain stationary with use of first and second chamber outer rims 760 and 800, respectively, or with use of tubular portion 781. Once first chamber 720 is properly situated, planting material, including soil and a plant or flower or other desired item may be placed within first chamber open area 770.

As the plant grows, water is added to the soil through open area 770, allowing the water to permeate through the soil and eventually either remain in the soil and be utilized by the plant, or exit first chamber 720 through the series of alternating voids 741. If the water exits first chamber 720, it will fall within the second chamber water reservoir 810. The water will remain within the water reservoir 810 until it is consumed by the plant, evaporated, or exits container 710 through a tubular opening 784 after it reaches a certain height.

The use of the tubular openings 784 will allow for water to exit container such that an excess of water is not formed in the water reservoir 810 and such that the level of the water cannot rise high enough to reach the first container 720 and permeate alternating voids 741 such that the water reenters the open area 770. In addition, with the sue of outer closure 745, roots will be forced to grow within water reservoir 810 and away from second chamber side wall 790.

It should be understood that although the above-described containerized plant growing solution systems, containers, and dividers, and methods of making and using the same are described as “comprising” one or more components or steps, the above-described containerized plant growing solution systems, containers, dividers and methods may “comprise,” “consists of,” or “consist essentially of” the above-described components or steps of the containerized plant growing solution systems, containers, dividers and methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a containerized plant growing solution system, container, divider or method that “comprises” a list of elements (e.g., components or steps) is not necessarily limited to only those elements (or components or steps), but may include other elements (or components or steps) not expressly listed or inherent to the containerized plant growing solution system, container, divider or method.

As used herein, the transitional phrases “consists of” and “consisting of” exclude any element, step, or ingredient not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a containerized plant growing solution system, container, divider or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described containerized plant growing solution systems, components thereof (e.g., containers, dividers, etc.), or methods may comprise, consist essentially of, or consist of any of the herein-described components and features, as shown in the figures with or without any feature(s) not shown in the figures. In other words, in some embodiments, the containerized plant growing solution system or component thereof (e.g., container, divider, etc.) of the present invention does not have any additional features other than those shown in the figures, and such additional features, not shown in the figures, are specifically excluded from the containerized plant growing solution system or component thereof (e.g., container, divider, etc.). In other embodiments, the containerized plant growing solution system or component thereof (e.g., container, divider, etc.) of the present invention does have one or more additional features that are not shown in the figures.

The present invention is described above and further illustrated below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

### Example 1

Exemplary containerized plant growing solution systems of the present invention, such as those detailed in FIGS. 1-20 and described above, were prepared and utilized to grow a variety of plants.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

### Example 2

In the summer of 2012 petunia ‘Ramblin nu blue’ were grown separately in greenhouse conditions using a conventional 12″ hanging basket (CC) as control, or a hanging basket in accordance with an embodiment of the present invention (RCH) to increase water holding (20, 30, and 40% of total hanging basket volume). The particular RCH utilized in Example 2 is the same as the embodiment illustrated in FIG. 8 without the water absorbing particles. The conventional hanging basket had no incremental water holding capacity (0%).

Plants were transplanted and grown in F-15 peat moss mix (Fafard, Agawam, Ma), irrigated and fertilized with constant liquid feed -CLF- (14-4-14) at 200 ppm N. All containers were irrigated at the same time using the control plants as indicators for irrigation. When plants reached bloom stage, they were subject to dry-down and days to commercial wilt were recorded. When a plant showed commercial wilt, it was fully hydrated for 3 days and rated as either marketable (showing commercial-grade attributes) or non-marketable.

The experiment was conducted as a complete randomized block design with five experimental units per treatment. Statistical analysis was performed with JMP 9.0 (SAS Corporation, Cary, N.C.).

### Results:

Plants grown in RCH hanging baskets had comparable developmental and flowering patterns as the CC plants (data not included). No negative effects or physiological disorders were observed in RCH plants during greenhouse production.

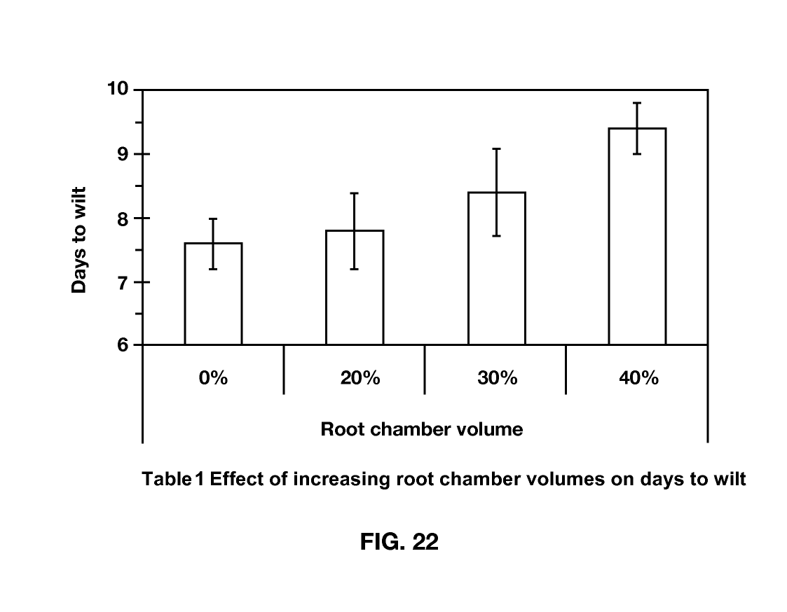

Plants showed incremental days to wilt as the hanging baskets with embodiments of the present invention volumes increased (Table 1 of FIG. 22). The plants of the conventional hanging basket (0%) and the RCH hanging baskets with water holding at 20% took 7.5 days to wilt, while petunias grown in the RCH hanging baskets with water holding of 30 and 40% lasted on average 8.5 and 9.5 to wilt, respectively.

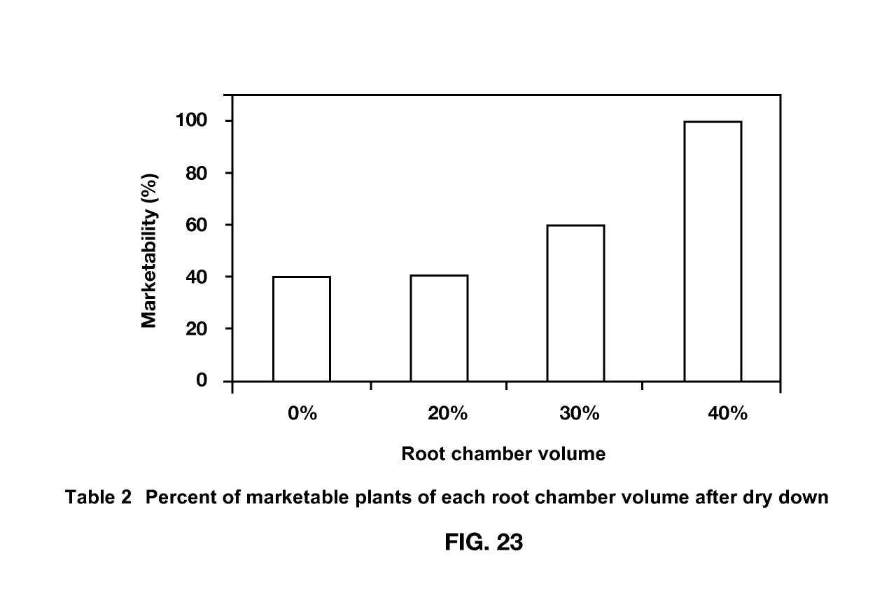

Marketability post dry-down was also influenced by increasing the water holding of the RCH hanging baskets (Table 2 of FIG. 23). Only 40% of plants grown in control and 20% RCH hanging baskets were marketable after being hydrated, compared to 60 and 100% marketable plants in the RCH hanging baskets with water holding of 30 and 40%.

### Example 3

Testing was completed to test dry down cycles in various pots that are available on the commercial market as well as those encompassed by the present invention. In particular, the pots utilized were a pot of FIGS. 24 and 25 (Treatment 1), an Eezy-Gro pot (Treatment 2), a standard pot (Treatment 3), a Hydrobox pot (Treatment 4), and a Nora EasyPot (Treatment 5). Each of the pots had an outer width between about 10.75″ and 12.75″ and a height of between about 6.50″ and 7.00″. Each pot was provided potting soil, standard fertilizer, and a petunia flower to grow. The flowers and pots were subject to a greenhouse phase (6 weeks following transplant), and then they were subject to cyclical dry-downs for 8 weeks. The number of days until a plant showed “wilt” symptoms was recorded, then the pot was fully irrigated (once) and the cycle started again for a total of 7 cycles. The results of the testing are shown below:

| | Cycle 1 | Cycle 2 | Cycle 3 | Cycle 4 | Cycle 5 | Cycle 6 | Cycle 7 |
|---|---|---|---|---|---|---|---|
| Treatment 1 | 13.5 a | 14.5 a | 11.2 a | 11.7 a | 9.0 a | Did not wilt* | Did not wilt* |
| Treatment 2 | 8.8 b | 9.2 b | 7.0 b | 7.0 b | 6.7 b | 10.8 a | Did not wilt* |
| Treatment 3 | 8.0 c | 8.5 b | 6.0 b | 7.0 b | 6.0 b | 8.0 b | 8.3 a |
| Treatment 4 | 8.0 c | 9.0 b | 6.2 b | 7.2 b | 6.2 b | 8.7 b | 7.4 a |
| Treatment 5 | 8.0 c | 9.3 b | 6.3 b | 6.7 b | 6.0 b | 9.2 ab | 8.1 a |

Values followed by different letters are significantly different (p = 0.05) according to Tukey's mean separation with n = 6
*Plants were fully turgid and did not reach wilt

### CONCLUSIONS

This experiment demonstrated that the root chamber system can be used to grow plants in commercial greenhouse production. The benefits of extended days to wilt and increased recovery post dry-down are commercially significant advantages and are applicable for enhanced post-harvest performance.

1. A container adapted to support plant growth and to be transportable, said container comprising:
an outer chamber comprising
a bottom surface
a side wall connected to said bottom surface and defining an open area,
an inner chamber comprising
a bottom surface comprising at least one aperture less than about 1 centimeter in width;
a side wall connected to said bottom surface and defining an open area;
wherein said aperture of inner chamber bottom surface is not positioned immediately adjacent said inner chamber side wall; and
wherein said inner chamber is placed within said outer chamber open area.

2. The container according to claim 1, wherein said inner chamber bottom surface comprises alternating apertures and closures.

3. The container according to claim 2, wherein said inner chamber bottom surface is circular and said alternating apertures and closures are situated in a concentric circle along inner chamber bottom surface.

4. The container according to claim 1, wherein said inner chamber bottom surface includes a center closure.

5. The container according to claim 1, wherein said outer chamber bottom surface comprises a hollow tubular portion that extends into outer chamber open area and includes at least one opening to allow access from outer chamber open area to an internal portion of hollow tubular portion.

6. The container according to claim 1, wherein said container further comprises a filter situated within said outer chamber open area.

7. The container according to claim 6, wherein said filter is constructed of a material of synthetic polymers, metal mesh, porous materials, natural fibers or mixtures thereof.

8. The container of claim 1, wherein the container further comprises a water level indicator that provides the user with an indication of the amount of water in outer chamber open area.
